(19) United States
(12) Patent Application Publication
(10) Pub. No.: US 2003/0088390 A1
(43) Pub. Date: May 8, 2003

(54) Method of performing channel simulation, and channel simulator

(76) Inventors: Tommi Jamsa, Oulu (FI); Juha Meinila, Kuopio (FI)

Correspondence Address: Finnegan, Henderson, Farabow,, Garrett & Dunner, L.L.P., 1300 I Street, N.W., Washington, DC, 20005-3315, US

(21) Appl. No.: 10/280,054

(22) Filed: Oct. 25, 2002

Related U.S. Application Data
(63) Continuation of application No. PCT/FI02/00157, filed on Feb. 26, 2002.

(30) Foreign Application Priority Data
Feb. 27, 2001 (FI) 20010392

(51) Int. Cl. G06G 7/48

(52) U.S. Cl. 703/5

(57) ABSTRACT

The invention relates to a method of performing channel simulation on a radio frequency signal and to a channel simulator for implementing the method. In the solution, the total band reserved for the signal to be applied to channel simulator units is divided into at least two sub-bands. Channel simulation is performed on signals corresponding to each sub-band in the channel simulator units. Finally, the signals simulated in the different sub-bands are combined to form a total band signal in a combiner after channel simulation.

### FIELD OF THE INVENTION

The invention relates to a radio channel simulator for simulating a radio channel.

### BACKGROUND OF THE INVENTION

When a radio frequency signal is transmitted from a transmitter to a receiver, the signal propagates in a radio channel along one or more paths having different signal phases and amplitudes, which causes fadings of different duration and strength in the signal. In addition, noise and interference caused by other transmitters interfere with the radio connection.

A transmitter and a receiver can be tested either in real circumstances or by using a radio channel simulator simulating real circumstances. Tests performed in real circumstances are cumbersome, since tests carried out outdoors, for example, are subject to uncontrollable phenomena, such as the weather and the time of the year, which change continuously. In addition, a test carried out in one environment (city A) is not totally valid in a second, corresponding environment (city B). The worst possible situation cannot either generally be tested in real circumstances.

However, a device simulating a radio channel can be used very freely to simulate a radio channel of the desired kind. In a digital radio channel simulator, a channel is usually modelled with a FIR filter (Finite Impulse Response filter), which generates convolution between the channel model and an applied signal by weighting the signal, delayed by different delays, with channel coefficients, i.e. tap coefficients, and by summing the weighted signal components. The channel coefficients are modified to correspond to the behaviour of a real channel.

However, the problem in devices simulating a radio channel is that the present component technology is incapable of producing a real-time, accurate and broadband simulator, neither analog nor digital. For instance down-mixing and up-mixing set high requirements on components in broadband simulation. In a digital simulator, the behaviour of a broadband signal in a channel cannot be simultaneously simulated fast and accurately, since the transformation accuracy is a function of the bandwidth such that the transformation accuracy deteriorates as the band widens. On the other hand, increasingly more accuracy is required of radio channel simulation.

### BRIEF DESCRIPTION OF THE INVENTION

The object of the invention is thus to provide an improved channel simulation method and a channel simulator implementing the channel simulation method for performing accurate and fast channel simulation. This is achieved by a method of performing channel simulation on a radio frequency signal in wireless data transfer. The method comprises dividing the total band reserved for the signal to be applied to channel simulation into at least two sub-bands; performing channel simulation on signals corresponding to each sub-band; and combining the signals simulated in different sub-bands to form a total band signal after channel simulation.

The invention also relates to a channel simulator for performing channel simulation on a radio frequency signal used in wireless data transfer. The channel simulator is arranged to divide the total band reserved for the signal to be applied to channel simulation into at least two sub-bands; and the channel simulator comprises at least two channel simulator units for performing channel simulation on signals corresponding to each sub-band; and a combiner for combining the signals simulated in different sub-bands to form a total band signal after channel simulation.

The preferred embodiments of the invention are disclosed in the dependent claims.

The invention is based on dividing the frequency band to be simulated into at least two sub-bands, and channel simulating the signals corresponding to each sub-band separately.

The method and system of the invention provide several advantages. A radio channel can be simultaneously simulated both accurately and fast, since the total band reserved for a signal is divided into sub-bands and each sub-band can be simulated with the best possible accuracy of the channel simulator.

### BRIEF DESCRIPTION OF THE FIGURES

In the following, the invention will be described in detail in connection with preferred embodiments with reference to the accompanying drawings, in which

FIG. 1A is a block diagram of a channel simulator,

FIG. 1B is a block diagram of a channel simulator,

FIG. 1C is a block diagram of a channel simulator,

FIG. 2 shows a FIR filter,

FIG. 3 shows a channel simulator based on convolution transformation, and

FIG. 4 shows sub-bands and the combination of sub-bands.

### DETAILED DESCRIPTION OF THE INVENTION

The solution presented is particularly well usable for the channel simulation of a broadband radio frequency signal (RF signal). Examples of suitable applications include for instance WLAN (Wireless Local Area Network), wireless mobile communication systems using frequency hopping, and other second, third and fourth generation mobile communication systems, without, however, any restriction thereto.

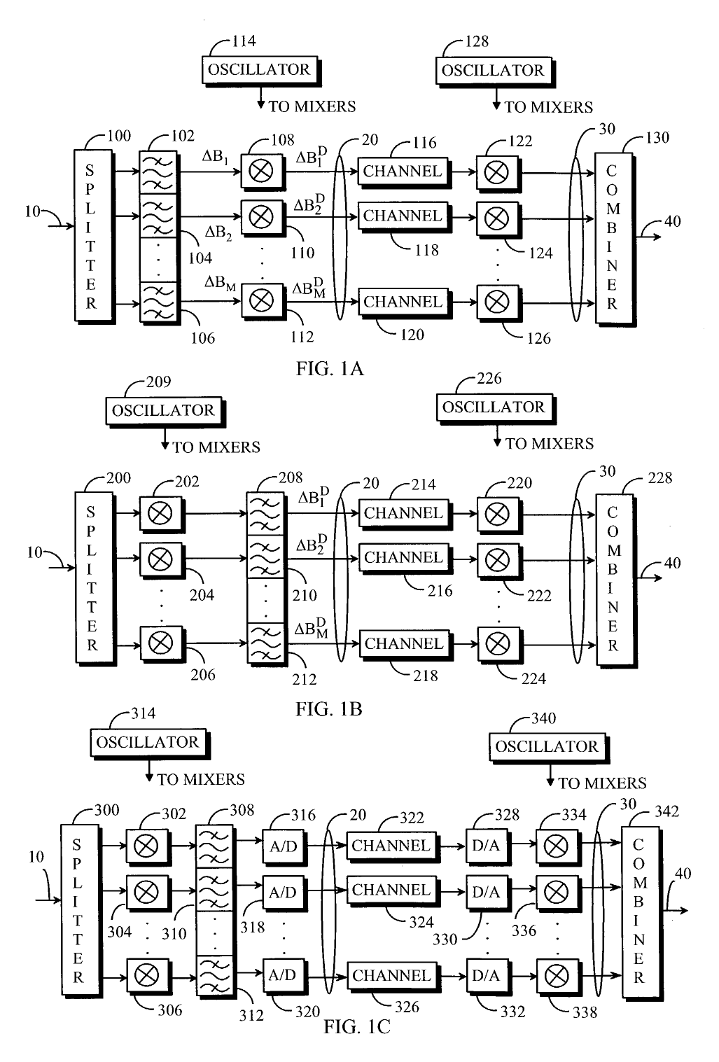

FIG. 1A shows a radio channel simulator for wireless data transfer according to the solution presented. An RF signal arriving at the radio channel simulator may be digital or, as is more common, analog. A frequency band B, reserved for the broadband signal, is for instance tens of megahertz, although the solution presented is not limited to the width of the frequency band. In a divider 100, the RF signal is divided into M signals of the original kind, where M is equal to or greater than two. Each divided signal is band-pass filtered in band-pass filters 102 to 106 into sub-bands ΔB₁ . . . ΔB_{M} in such a way that the sum of the sub-bands is the total band B of the RF signal, i.e. B=ΔB₁+ . . . +ΔB_{M}. The bandwidth of each sub-band may be equal or different. The frequency of sub-bands ΔB₁. . . ΔB_{M} is reduced in mixers 108 to 112 for instance by multiplying the signal of each sub-band by the signal of a local oscillator 114 and by low-pass or band-pass filtering the input signal, whereby sub-bands ΔB₁^{D} . . . ΔB_{M}^{D} having lowered frequencies are generated. The signal of a local oscillator 114 arriving at each mixer 108 to 112 may be at the same or a different frequency. When a local oscillator 114 signal at a different frequency is used in the different mixers 108 to 112, the intermediate frequency of the sub-bands ΔB₁^{D} . . . ΔB_{M}^{D} having lowered frequencies can be set to be the same, allowing all sub-bands to be simulated with the same accuracy if all sub-bands have the same bandwidth. The sub-bands ΔB₁^{D} . . . ΔB_{M}^{D} having lowered frequencies each propagate to different channel simulator units 116 to 120, the number of units being M. After the channel simulation performed by the channel simulator units 116 to 120, the signals of the sub-bands are returned to the original RF frequencies by multiplying the signals in mixers 122 to 126 by signals coming from a local oscillator 128, and by high-pass or band-pass filtering the input signal. The RF frequency signals of the sub-bands are combined in a combiner 130 to form a broadband total band.

FIG. 1B shows another manner of implementing the division into sub-bands. In this solution, the frequency band B of a broadband RF signal is divided in a divider 200 into M bands. Each one of the M bands have the same bandwidth as the original frequency band. The divided RF signal is multiplied in mixers 202 to 206 by the signal of a local oscillator 209. The signal of the local oscillator 209 arriving at each mixer 202 to 206 may be at the same or a different frequency. The signal, mixed in band-pass filters 208 to 212, is band-pass filtered into sub-bands ΔB₁^{D} . . . ΔB_{M}^{D}, which correspond to the sub-bands of FIG. 1A. The sub-bands ΔB₁^{D} . . . ΔB_{D}^{M} having lowered frequencies each propagate to different channel simulator units 214 to 218, the number of units being M. As regards the solution presented, it is essential that in both FIG. 1A and FIG. 1B, the frequency band of the signal to be applied to the channel simulator units is divided into at least two sub-bands to perform channel simulation in at least two parallel channel simulations. Thereafter, the channel simulation operates in the same way as in the case of FIG. 1A. After the channel simulation performed by the channel simulator units 214 to 218, the signals of the sub-bands are returned to the original RF frequencies by multiplying the signals in mixers 220 to 224 by signals coming from a local oscillator 226, and by high-pass or band-pass filtering the input signal. The RF frequency signals of the sub-bands are combined in a combiner 228 to form a broadband total band.

FIG. 1C shows a radio channel simulator according to FIG. 1B, at which an analog RF signal arrives. In a divider 300, the RF signal is divided into M signals of the original kind. The divided RF signal is multiplied in mixers 302 to 306 by the signal of a local oscillator 314. The signal of the local oscillator 314 arriving at each mixer 302 to 306 may be at the same or a different frequency. The signal, mixed in band-pass filters 308 to 312, is band-pass filtered into sub-bands ΔB₁^{D} . . . ΔB_{M}^{D}. The analog sub-bands ΔB₁^{D} . . . ΔB_{M}^{D} are transformed into digital in analog-to-digital transformers 316 to 320 (A/D trans-former). The digital sub-bands ΔB₁^{D} . . . ΔB_{M}^{D} each propagate to different channel simulator units 322 to 326, the number of units being M. After the channel simulation performed by the channel simulator units 322 to 326, the sub-bands are transformed back to analog in digital-to-analog transformers 328 to 332 (D/A transformer). The analog sub-bands are returned to the original RF frequencies by multiplying the sub-bands in mixers 334 to 338 by signals coming from a local oscillator 340, and by high-pass or band-pass filtering the input signal. The RF frequency signals of the sub-bands are combined in a combiner 342 to form a broadband total band.

In FIG. 1C, the order of the mixers 302 to 306 and the band-pass filters 308 to 312 may also be similar to that in FIG. 1A, i.e. the mixing takes place before the band-pass filtering.

In different channel simulator units, the radio channel model may be the same or different, but each channel simulator unit can be used to perform the channel simulation independently. Having the same channel model in all channel simulator units corresponds to a situation where only one channel simulator unit is available. Particularly if the total band to be simulated is broad, the channel may so different in different sub-bands that a different channel model is required for the different sub-bands. The advantage of the solution presented is that the simulation can be performed more accurately than by the use of only one channel simulator unit. In digital channel simulation, the accuracy can be seen in that, compared with one channel simulator, the solution presented has at least a double number of samples available for the same total band. This enables more accurate modelling of the radio channel. The channel simulator can also be used to compensate for amplification and phase errors occurred for instance in mixing and in analog-to-digital transformation.

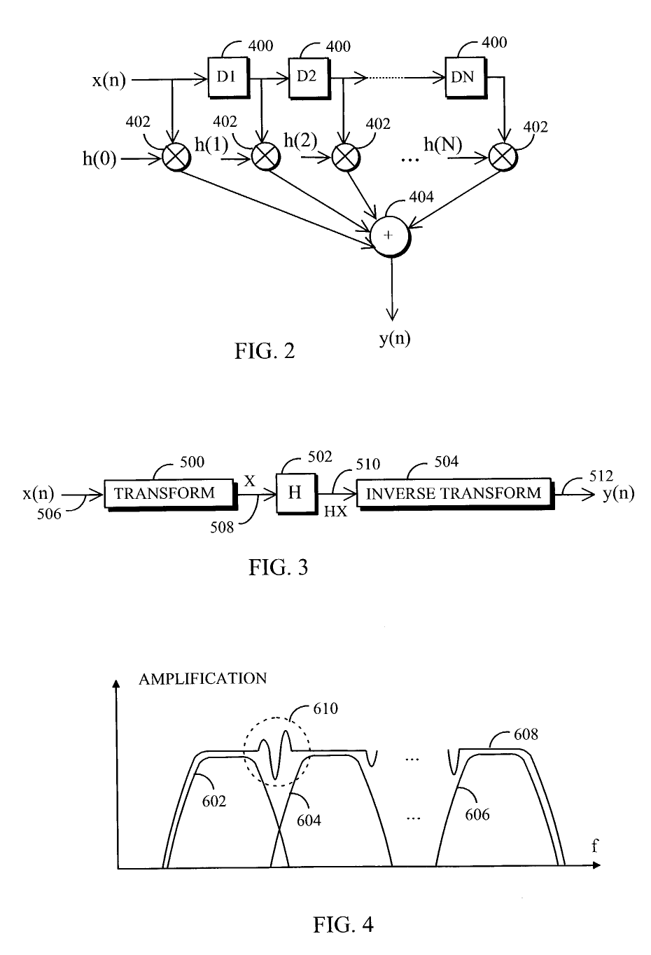

In each channel simulator, a radio channel can be simulated for instance by means of a digital FIR filter, whose block diagram is shown in FIG. 2. The FIR filter comprises delay elements 400 arranged as a shift register, weight coefficient blocks 402 and a summer 404. An input signal x(n) is delayed in each delay element 400, whose delays may have the same or different length in time, and the delayed signals are weighted in the weight coefficient blocks 402 by the desired weight coefficient h(i), where i=[b 0, . . . , N]. The weight coefficients h=[h(0), . . . , h(N)] are channel estimates of the radio channel, also called tap coefficients of the FIR filter. The weight coefficients are changed in the same way as the characteristics of a real radio channel are thought to change. Usually weight coefficients are quite stable in the short run, but change slowly compared with the variation rate of the signal. The delayed and weighted signals are summed in a summer 404.

Generally, weight coefficients may be real or complex. Complex weight coefficients are needed since for instance a radio channel of the GSM (Global System for Mobile communication) or CDMA radio system (Code Division Multiple Access) uses quadrature modulation, wherein a signal is divided into two parts. The real signal part I (Inphase) is multiplied by a carrier without phase shift and the imaginary signal part Q (Quadrature) is multiplied by a phase shifted carrier. Thus signal x can be expressed in the form x=I+jQ, where I is the real signal part, Q is the imaginary signal part and j is an imaginary unit.

In mathematical form, the output signal y(n) of the FIR filter can be expressed as convolution as the sum of the product of the delayed signal and the weight coefficients:

$$y ( n ) = x * h = {\sum }_{k = 1}^{N} h ( k ) x ( n - k ) \qquad ( 1 )$$

where

* denotes a convolution operation and n denotes the index of a signal element. Signals x and y and channel impulse response h can be processed as scalar, in vector form or in matrix form in a manner known per se.

A radio channel can be simulated in each channel simulator in a transformation space. The block diagram of such a channel simulator is shown in FIG. 3. In this case, a signal 506 (x(n)) to be applied to simulation is transformed by convolution transformation into the transformation space in transformation means 500, thereby generating a transformed signal 508 (X). In weighting means 502, the transformed signal 508 (X) is weighted by a channel response H transformed by convolution transformation, generating a signal 510 (HX). The weighting can be carried out for instance by a multiplication operation. However, the multiplication per se can be implemented by one or more mathematical operations without actual multiplication to speed up the calculation. Finally, the input signal 510 (HX) is inversely transformed in inverse transformer means 504 into a time space, generating an output signal 512 (y(n)). The convolution transformation used in channel simulation may be for instance a Laplace, Z, Fourier transform or the like.

The division into sub-bands may cause interference and mismatching in the frequency range between the sub-bands. This can be seen when sub-bands are combined. FIG. 4 shows the combination of sub-bands. The vertical axis shows band-specific amplification on a freely selected scale, and the horizontal axis shows the frequency. Curves 602 to 606 depict the sub-bands ΔB₁ . . . ΔB_{M} and curve 608 depicts the total band. Interference 610 on the combined total band appears in the range between the sub-bands. The magnitude of the interference depends on signal phasing in the different sub-bands. The problem may be alleviated by the use of an equalizer, which filters off any interference between sub-bands ΔB₁ . . . ΔB_{M}. For filtering interference, filtering methods, known per se, can be used to cut off high sudden deviations. Equalizing filtering can be performed before or after the sub-bands are combined (for example in FIG. 1C in combiner 342).

Although the invention is described above with reference to the example according to the accompanying drawings, it is apparent that the invention is not limited thereto, but can be modified in a variety of ways within the scope of the inventive idea disclosed in the attached claims.

1. A method of performing channel simulation on a radio frequency signal in wireless data transfer the method comprising:
dividing the total band reserved for the signal to be applied to channel simulation into at least two sub-bands;
performing channel simulation on signals corresponding to each sub-band; and
combining the signals simulated in different sub-bands to form a total band signal after channel simulation.

2. A method as claimed in claim 1, the method further comprising performing separate independent channel simulation on the signals corresponding to each sub-band.

3. A method as claimed in claim 1, the method further comprising using, in channel simulation, a different channel model for at least two signals corresponding to a different sub-band.

4. A method as claimed in claim 1, the method further comprising using, in channel simulation, the same channel model for at least two signals corresponding to a different sub-band.

5. A method as claimed in claim 1, the method further comprising performing channel simulation on a broadband signal, lowering the frequency of the broadband radio frequency signal before applying it to channel simulation and restoring the channel simulated signal to a radio frequency signal after channel simulation.

6. A method as claimed in claim 1, the method further comprising lowering the frequency of an analog radio frequency signal before applying it to channel simulation and restoring the channel simulated signal to a radio frequency signal after channel simulation; and
transforming, after lowering the frequency, the analog radio frequency signal to digital and performing channel simulation digitally and transforming the channel simulated signal back to analog after channel simulation.

7. A method as claimed in claim 1, the method further comprising reducing the interference between the sub-bands by means of equalizing filtering when the signals of the different sub-bands are combined.

8. A method as claimed in claim 1, the method further comprising performing the channel simulation with a FIR filter.

9. A method as claimed in claim 1, the method further comprising performing the channel simulation of each sub-band in such a way that the signal to be applied to the channel simulation is transformed by convolution transformation into a transformation space, thus generating a transformed signal;
weighting the transformed signal by convolution transformation by a transformed channel response H, thus generating a weighted signal; and
inversely transforming the weighted signal, thus generating a sub-band-specific channel simulated signal.

10. A channel simulator for performing channel simulation on a radio frequency signal used in wireless data transfer, wherein the channel simulator is arranged to divide the total band reserved for the signal to be applied to channel simulation into at least two sub-bands; and the channel simulator comprises
at least two channel simulator units for performing channel simulation on signals corresponding to each sub-band; and
a combiner for combining the signals simulated in different sub-bands to form a total band signal after the channel simulation.

11. A channel simulator as claimed in claim 10, wherein the channel simulator units are arranged to perform separate independent channel simulation on the signals corresponding to each sub-band.

12. A channel simulator as claimed in claim 10, wherein at least two different channel simulator units are arranged to use, in channel simulation, a different channel model for at least two signals corresponding to a different sub-band.

13. A channel simulator as claimed in claim 10, wherein that at least two different channel simulator units are arranged to use, in channel simulation, the same channel model for at least two signals corresponding to a different sub-band.

14. A channel simulator as claimed in claim 10, wherein the channel simulator is arranged to simulate the behaviour of a broadband signal in a radio channel and the channel simulator comprises mixers for lowering the frequency of a broadband radio frequency signal before the channel simulator units, and the channel simulator comprises mixers for restoring the channel simulated signal to a radio frequency signal after the channel simulator units.

15. A channel simulator as claimed in claim 10, wherein the channel simulator comprises mixers for lowering the frequency of an analog radio frequency signal before the channel simulator units, and the channel simulator comprises mixers for restoring the channel simulated signal to a radio frequency signal after the channel simulator units; and
the channel simulator comprises A/D transformers for transforming, after the mixers, the analog radio frequency signal to digital, and the channel simulators are arranged to perform channel simulation digitally, and the channel simulator comprises D/A transformers for transforming the channel simulated signal back to analog after the channel simulator units.

16. A channel simulator as claimed in claim 10, wherein the mixer is arranged to reduce the interference between the sub-bands by means of equalizing filtering.

17. A channel simulator as claimed in claim 10, wherein the channel simulator units are implemented as FIR filters.

18. A channel simulator as claimed in claim 10, wherein at least one channel simulator unit comprises
transformation means, in which the signal is transformed by convolution transformation into a transformation space for generating a transformed signal;
weighting means for weighting the transformed signal by convolution transformation for generating a signal weighted by a transformed channel response H; and
inverse transformation means for inversely transforming the input signal into a time space for generating a sub-band-specific channel simulated signal.
